(19) United States
(12) Patent Application Publication
(10) Pub. No.: US 2008/0170305 A1
(43) Pub. Date: Jul. 17, 2008

(54) LENS MODULE AND METHOD FOR MAKING SAME

(75) Inventor: TIEN-WU TSAI, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/757,171

(22) Filed: Jun. 1, 2007

(30) Foreign Application Priority Data
Jan. 12, 2007 (CN) 200710200051.9

(51) Int. Cl. G02B 7/02; B29D 11/00

(52) U.S. Cl. 359/819; 264/1.1

(57) ABSTRACT

A lens module includes a holder and a barrel. The barrel has at least one lens received therein. At least one given lens is integrated with the barrel and the holder. A method for making a lens module includes the steps of: providing a die assembly having a molding cavity configured for forming an integrated structure including a lens, a barrel, and a holder; placing a moldable material capable of being molded as the integrated structure into the molding cavity; and forming the moldable material into the integrated structure.

### BACKGROUND

1. Technical Field

The present invention relates to lens modules and, particularly, to a lens module having an integrated lens, barrel, and holder and to a method for making the lens module.

2. Description of Related Art

With the development of the optical imaging technology, camera devices are becoming widely used in electronic devices, such as digital cameras and mobile phones.

Referring to FIG. 4, a typical camera device 1 includes a lens 2, a barrel 3, a holder 4, and an image sensor 5. The barrel 3, with the lens 2 received therein, is threadingly coupled with the holder 4. The image sensor 5 is disposed at the bottom of the holder 4.

The lens 2, barrel 3 and holder 4, together constituting a lens module, are all independent components. So, at least three types of die assembly for molding the lens 2, barrel 3, and holder 4 need to be used in producing the lens module and the camera device 1. Further, once such elements are produced, they then need to be assembled together. Accordingly, manufacture and assembly of the lens module and the camera device 1 has a high production cost, both in terms of time and money.

It is therefore desirable to find a lens module and a camera device and to likewise find a new method capable of producing such, in order to overcome the above mentioned problems.

### SUMMARY

In accordance with one embodiment, a lens module includes a holder and a barrel. The barrel has at least one lens received therein, the barrel being received in the holder. One of the at least one lenses is integrated (e.g., co-molded) with the barrel and the holder.

In accordance with one embodiment, a method for making a lens module includes the steps of: providing a die assembly having a molding cavity configured for forming an integrated structure including a lens, a barrel, and a holder; putting a material capable of being molded as the integrated structure into the molding cavity; and forming the integrated structure.

In accordance with one embodiment, a camera device includes a holder, an image sensor, and a barrel. The image sensor is received in the holder. The barrel has at least one lens received therein. One of the at least one lenses is integrated with the barrel and the holder.

### BRIEF DESCRIPTION OF THE DRAWING

Many aspects of the present integrated lens module and related camera can be better understood with reference to the following drawings. The components in the drawing are not necessarily drawn to scale, the emphasis instead being placed upon clearly illustrating the principles of the present integrated lens module and related camera. Moreover, in the drawing, like reference numerals designate corresponding parts throughout the several views.

FIG. 1 is a schematic, cross-sectional view of a camera device, according to a present embodiment;

FIG. 2 is a schematic, cross-sectional view of a die assembly according to a method for making the lens module of the camera device of FIG. 1;

FIG. 3 is a flow chart of a method for making the camera device of FIG. 1; and

FIG. 4 is a schematic, cross-sectional view of a typical camera device.

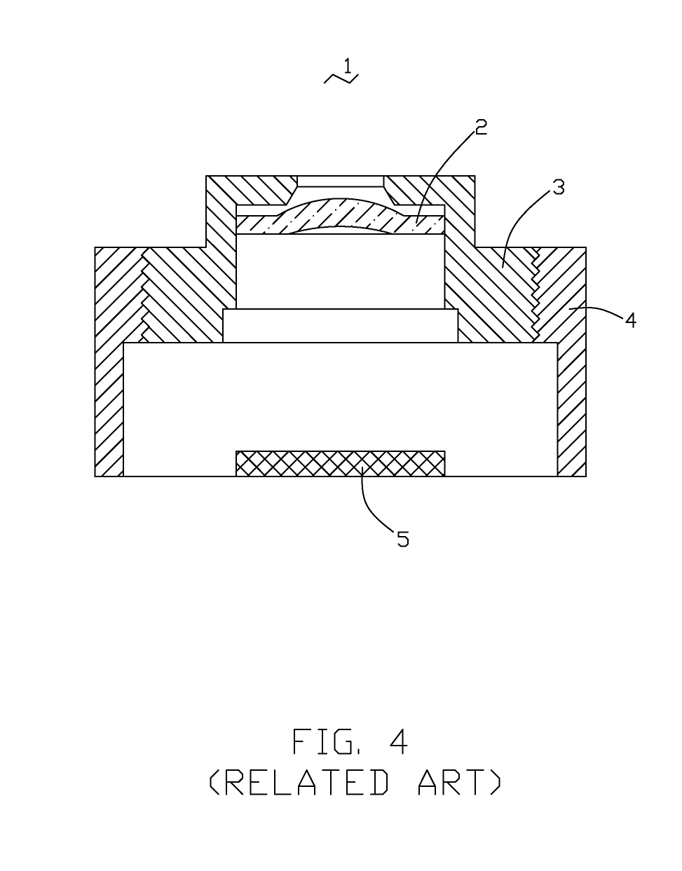

### DETAILED DESCRIPTION OF THE EMBODIMENTS

Embodiments will now be described in detail below with reference to the drawings.

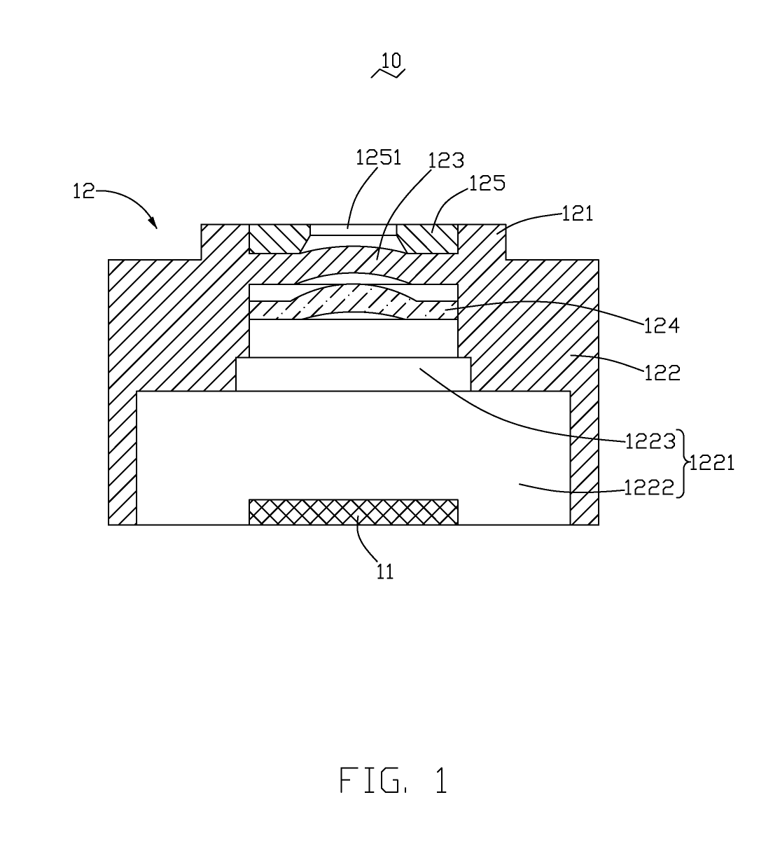

Referring to FIG. 1, a camera device 10 according to a present embodiment is shown. The camera device 10 includes an image sensor 11 and a lens module 12. The lens module 12 includes a barrel 121, a holder 122, a first lens 123, and a second lens 124. The first lens 123 and a second lens 124 are received in the barrel 121, in that order, from an object side of the lens module 12 to an image side of the lens module 12, and the barrel 121, in turn, is integrally (e.g., moldingly) received in the holder 122. The holder 122 has a cavity 1221 at the bottom of the holder 122. The image sensor 11 is received in the cavity 1221 and is optically aligned with the first lens 123 and the second 124. In the present embodiment, the cavity 1221 has a first cavity portion 1222 and a second cavity portion 1223. The first cavity portion 1222 is an approximate shape of a cube and/or a rectangular parallelepiped. The second cavity portion 1223 extends above the first portion 1222 that is substantially a cylinder or a stepped cylinder. The first cavity portion 1222 and second cavity portion 1223 openly communicate with one another. The image sensor 11 is specifically received in the first cavity portion 1222, and the second cavity portion 1223 is both shaped and is big enough (i.e., is, thus, properly structured) for assembling/receiving the second lens 124 into the barrel 121.

The image sensor 11 can, e.g., be a charge-coupled device (CCD) or a complementary metal oxide semiconductor device (CMOS). The image sensor 11 could further be selected from a ceramic leaded chip carrier (CLCC) package type image sensor, a plastic leaded chip carrier (PLCC) package type image sensor, or a chip scale package (CSP) type image sensor.

In present embodiment, the first lens 123 is integrated (e.g., co-molded) with the barrel 121 and the holder 122. The first lens 123, the barrel 121, and the holder 122 can, beneficially, be made of a same material, such as an optical plastic or glass. The integrated structure of the first lens 123, the barrel 121 and the holder 122 can be formed by injection molding or press-molding. It is to be understood that a co-molding (e.g., co-injection) procedure could, alternatively, be chosen that would allow for different materials to be used for the various components. For example, a structural plastic or glass could then be used for the barrel 121 and the holder 122, and an optical plastic or glass be employed for the first lens 123.

In the embodiment illustrated in FIG. 1, a shading-ring 125 is disposed on the top of the barrel 121 and at the object side of the first lens 123. The shading-ring 125 is configured (i.e., structured and arranged) for controlling the flux of light entering the barrel 121. The shading-ring 125 has a hole 1251 at the center thereof. Preferably, the diameter of the hole 1251 is smaller than the diameter of the first lens 123, so that the shading-ring 125 can function as an aperture. The second lens 124 can be secured in the barrel 121 using an adhesive/glue.

Because the barrel 121 and the holder 122 are made of the same material (i.e., an optical material) as the first lens 123, unusable/unwanted light (i.e., light not associated with the image being captured) can enter the lens module 12 by crossing through the barrel 121 and/or the holder 122. In order to avoid the unwanted light entering the lens module 12, advantageously, the outer surface of the holder 122 and the barrel 121 is blackened or otherwise made opaque (e.g., via a coating or a surface treatment). Preferably, the inner surface of the holder 122 and the barrel 121 is also made opaque in order to avoid undesired light being reflected onto the first lens 123 and/or the second lens 124.

It can be understood that, in another embodiment, the lens module 12 could have just one lens, the first lens 123. It can also be understood that, in yet another embodiment, the first lens 123 can be an independent component, and the second lens 124 can be integrated with the barrel 121 and the holder 122. Further alternatively, the lens module 12 can have more than two lenses. Even yet further alternatively, it may be possible to co-mold both the first lens 123 and the second lens 124 as part of the integrated lens module.

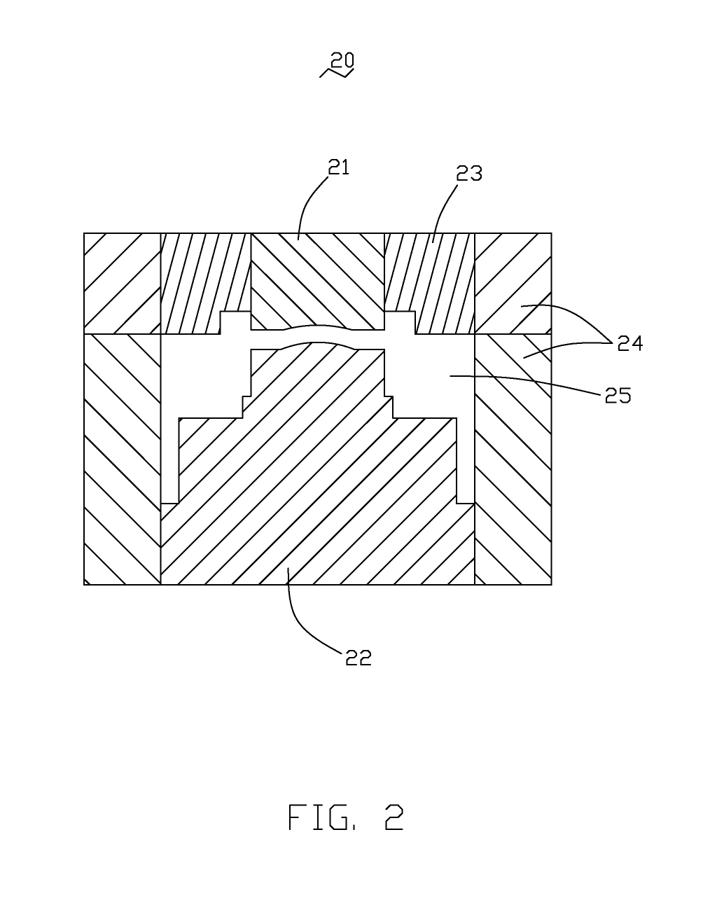

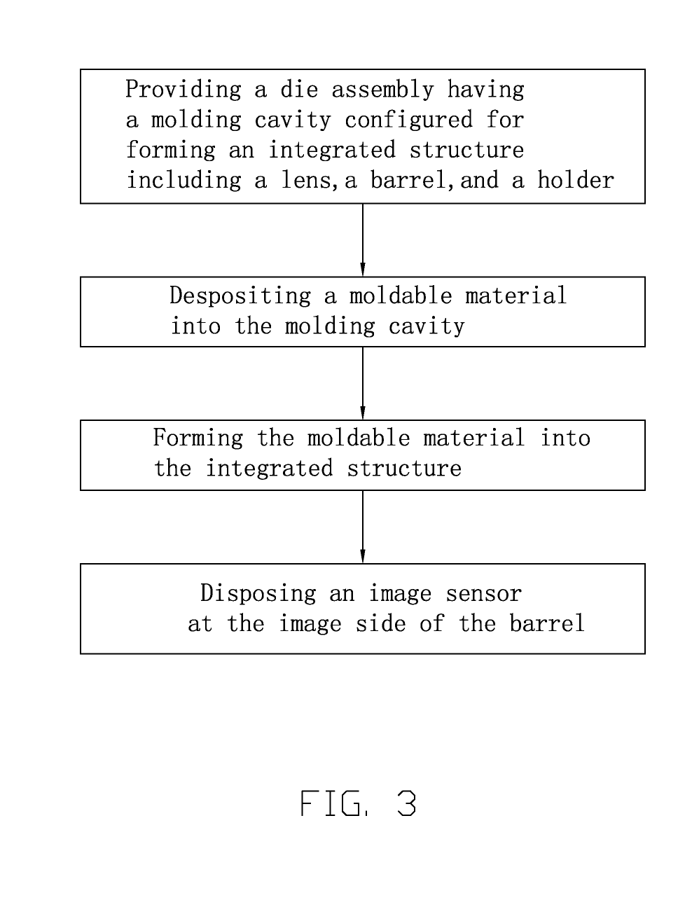

A method for making the camera device 10 is also provided. Referring to FIG. 2 and FIG. 3, the method includes the steps of: providing a die assembly 20 having a molding cavity 25 configured for forming an integrated structure (i.e., the lens module 12) including the first lens 123, the barrel 121 and the holder 122; putting/depositing a chosen moldable material into the molding cavity 25; forming the chosen moldable material into the integrated structure, using the die assembly 20; and disposing/mounting an image sensor 11 at the image side of the barrel 121 and in optical alignment with the first lens 123 and the second lens 124.

In the present embodiment, the die assembly 20 includes a upper die 21, a lower die 22, a bushing 23, and a tubular guide die 24. The upper die 21 and the lower die 22 are configured for sliding movement within the tubular guide die 24. The bushing 23 is made of a wear-resistant material and is configured for preventing or at least substantially reducing the potential for wear of the upper die 21 when the upper die 21 is sliding within the tubular guide die 24. The material can, for example, be an optical glass or plastic. The step of forming the integrated structure includes taking the integrated structure out from the molding cavity 25 after molding and, if necessary, sufficient cooling is complete. The image sensor 11 can, e.g., be a charge-coupled device (CCD) or a complementary metal oxide semiconductor device (CMOS).

The method can further include assembling at least one lens into the barrel 121 of the integrated structure before disposing an image sensor 11 at the image side of the barrel 121. The at least one lens can, usefully, be secured in the barrel 121 using an adhesive/glue. The method can further include blackening or otherwise rendering opaque the outer and inner surface of the barrel 121 and the holder 122 after forming the integrated structure. The die assembly 20 can, for example, be selected from an injection molding die assembly or a press-molding die assembly.

As stated above, a lens, a barrel, and a holder of the lens module for use in a camera device are formed as an integrated structure, and only one type of die assembly is needed for molding them. Accordingly, the number of the types of the die assembly using in producing the lens module and the camera device can be reduced, and the cost of the lens module and the camera device can be scaled down. Furthermore, the lens module and the camera device have fewer independent components compared to the typical lens module and camera device, so they are easy to assemble, thus reducing the cost and time associated with assembly. It is to be understood, however, that other advantages could also be associated with the present lens module, and such inherent/latent benefits are considered to be within the scope of the present lens module and method of making such.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. A lens module comprising:
a holder; and
a barrel having at least one lens received therein, the barrel being received in the holder;
wherein at least one given lens is integrated with the barrel and the holder.

2. The lens module as claimed in claim 1, wherein one given lens is the lens nearest to an object side of the lens module.

3. The lens module as claimed in claim 1, wherein the at least one given lens, the barrel, and the holder are made of a same material.

4. The lens module as claimed in claim 1, the at least one given lens, the barrel, and the holder are comprised of a material selected from the group consisting of optical plastic and optical glass.

5. The lens module as claimed in claim 1, wherein a shading-ring is disposed on the top of the barrel, the shading-ring being configured for controlling the flux of incident light.

6. The lens module as claimed in claim 1, wherein the outer surface of the holder and the barrel is made opaque.

7. The lens module as claimed in claim 1, wherein the outer surface and the inner surface of the holder and the barrel are made opaque.

8. A method for making a lens module, comprising the steps of:
providing a die assembly having a molding cavity therein, the molding cavity being configured for forming an integrated structure, the integrated structure including a lens, a barrel, and a holder;
depositing a moldable material into the molding cavity; and
forming the moldable material into the integrated structure.

9. The method as claimed in claim 8, wherein the method further comprises assembling at least one additional lens into the barrel of the integrated structure, after forming the integrated structure.

10. The method as claimed in claim 8, wherein the method further comprises making opaque the outer and inner surface of the barrel and the holder, after forming the integrated structure.

11. The method as claimed in claim 8, wherein the die assembly is one of an injection molding die assembly and a press-molding die assembly.

12. A camera device comprising:
a holder;
an image sensor received in the holder; and
a barrel having at least one lens received therein, the barrel being received in the holder;
wherein at least one given lens is integrated with the barrel and the holder.

13. The camera device as claimed in claim 12, wherein one given lens is the lens nearest to an object side of the camera device.

14. The camera device as claimed in claim 12, wherein the at least one given lens, the barrel, and the holder are made of a same material.

15. The camera device as claimed in claim 12, wherein the at least one given lens, the barrel, and the holder are all comprised of a same material selected from the group consisting of optical plastic and optical glass.

16. The camera device as claimed in claim 12, wherein a shading-ring is disposed on the top of the barrel, the shading-ring being configured for controlling the flux of incident light.

17. The camera device as claimed in claim 12, wherein the outer surface of the holder and the barrel is rendered opaque.

18. The camera device as claimed in claim 12, wherein the outer surface and the inner surface of the holder and the barrel are rendered opaque.
